(19) United States
(12) Patent Application Publication
(10) Pub. No.: US 2018/0113054 A1
(43) Pub. Date: Apr. 26, 2018

(54) Chassis Dynamometer Having Mechanical Configuration That Reduces Size While Maintaining Functionality

(71) Applicant: AVL Test Systems, Inc., Plymouth, MI (US)

(72) Inventors: Kenneth C. BARNES, Sedona, AZ (US); Jonathan BUSHKUHL, Canton, MI (US)

(21) Appl. No.: 15/784,680

(22) Filed: Oct. 16, 2017

Related U.S. Application Data
(60) Provisional application No. 62/412,096, filed on Oct. 24, 2016.

(51) Int. Cl. G01M 17/007; G01L 3/16

(52) U.S. Cl. CPC G01M 17/0072; G01L 3/16

(57) ABSTRACT

A dynamometer system may include a first dynamometer roll, a second dynamometer roll, a first motor, and a second motor. The first dynamometer roll is supported for rotation about a rotational axis. The second dynamometer roll is supported for rotation about the rotational axis. The first motor may include an output shaft coupled to the first dynamometer roll for rotation therewith. The first motor may be drivingly connected to the first dynamometer roll at a first location. The second motor may include an output shaft coupled to the second dynamometer roll for rotation therewith. The second motor may be drivingly connected to the second dynamometer roll at a second location. The first motor may be disposed between the first and second locations in a direction extending along the rotational axis. The second location may be disposed between the first and second motors in the direction extending along the rotational axis.

### CROSS-REFERENCE TO RELATED APPLICATIONS

This application claims the benefit of U.S. Provisional Application No. 62/412,096, filed on Oct. 24, 2016. The entire disclosure of the above application is incorporated herein by reference.

### FIELD

The present disclosure relates to a dynamometer, and more particularly, to a chassis dynamometer having a mechanical configuration that reduces the size of the chassis dynamometer while maintaining or improving its functionality.

### BACKGROUND AND SUMMARY

This section provides background information related to the present disclosure and is not necessarily prior art.

Dynamometers, often referred to simply as “dynos,” are devices that measure the performance of a machine. Most commonly, dynamometers are utilized to measure the performance of a vehicle, and more specifically, the power and torque generated by the vehicle's engine, which is typically transferred to the dynamometer through associated powertrain components. In addition to measuring power and torque, dynamometers can be used to determine friction and pumping losses or to simulate road loading conditions for emissions testing, durability testing, and extreme temperature testing.

There are several forms of dynamometers that are commonly used for vehicle testing. These include engine dynamometers, chassis dynamometers, and powertrain dynamometers. Engine dynamometers couple directly to the vehicle's engine and measure power and torque directly from the engine's crankshaft. Such engine dynamometers typically require the vehicle's engine to be removed from the vehicle and do not account for power losses in the vehicle's drivetrain, gearbox, transmission, or differential. Accordingly, engine dynamometers are typically used by engine manufacturers to test engines before they are installed in a vehicle.

Chassis dynamometers generally include a chassis dynamometer roll that is driven by the drive wheels of the vehicle during testing. Chassis dynamometers measure the power drive wheels of the vehicle deliver to one or more chassis dynamometer rolls. As such, chassis dynamometers are sometimes referred to as “rolling road” dynamometers because the rotating chassis dynamometer rolls simulate on-road operation. Before testing, the vehicle can simply be driven up onto the chassis dynamometer rolls and anchored in place.

Powertrain dynamometers generally include a powertrain dynamometer shaft that is driven by at least one powertrain component of the vehicle during testing. Typically, the powertrain dynamometer shaft is connected to the hubs of the vehicle for direct power and torque measurement from the vehicle's drive axle.

All of these various types of dynamometers have some form of dynamometer motor. The dynamometer motor includes a motor shaft that is rotatably coupled to the driven component(s) of the dynamometer (e.g., one or more dynamometer rolls of a chassis dynamometer). Such dynamometer motors provide power and torque measurements and are typically large components that increase in size as their maximum load range increases. Accordingly, the dynamometer motors used to test heavy duty and multi-axle vehicles take up significant space. Many dynamometers are situated inside a test chamber (or test cell). This is particularly true where vehicle testing is performed at specific temperatures. For example, some tests are conducted at extreme temperatures within the test chamber, including very low temperatures such as −65° C. (Celsius). Test chambers are thus defined by at least one chamber wall that isolates the vehicle from ambient temperatures. Climate control equipment controls the temperature within the test chamber such that the vehicle can be tested at extreme temperatures. Such test chambers are typically large in size because they must provide enough room for not only the vehicle, but also the entire dynamometer assembly, including the dynamometer motor.

The size of such test chambers thus becomes problematic from a climate control standpoint. It becomes very costly to maintain the test chamber at extreme temperatures during a test given the large volume of air within the test chamber that must be heated or cooled. Stated another way, large amounts of energy are consumed in order to maintain large test chambers at extreme temperatures during testing.

Chassis dynamometers designed for testing vehicles of various sizes including large trucks (e.g., Class 8 trucks) often include a large-diameter dynamometer roll (e.g., a 72 inch diameter roll). In order to generate a desired amount of torque, such chassis dynamometers may include a motor drivingly connected to each side of the large-diameter roll, as shown in FIGS. 1 and 2. This configuration requires a very wide foundation and a very wide test chamber to accommodate this setup. The cost to implement and operate such large test chambers can be quite high due to the high cost of climate controlling such large chambers and the high cost associate with occupying a large area of a building.

Some chassis dynamometers may have a motor-in-the-middle configuration which includes a single motor disposed between two rolls and drivingly connected to the two rolls. This configuration significantly reduces the overall width of the system (and thus reduces the overall size of the test chamber). However, the single motor driving two rolls does not allow the left and right wheels of the vehicle to rotate at different speeds and/or be loaded differently. The ability to rotate the left and right wheels at different speeds and to load the left and right wheels differently is desirable for simulating realistic driving conditions such as cornering (i.e., turning the vehicle around corners). The effects of cornering influence the overall fuel economy of the vehicle and have an impact on the exhaust emissions of the vehicle.

For accurate exhaust emission measurement, it is desirable to simulate real-world driving conditions (which includes cornering and loading the left and right wheels differently, at times), and it is desirable to position exhaust emission measurement equipment in close proximity to the vehicle tailpipe. For testing the emissions of heavy-duty diesel vehicles, it may be desirable to position a large and long particulate tunnel underneath the test chamber floor (e.g., in a basement) as close as possible to the vehicle tailpipe.

In the motor-in-the-middle configuration, the diameter of the motor is limited by the inside diameter of the rolls. Furthermore, motor diameter is proportional to motor torque. Therefore, since a single motor drives two rolls and the diameter of that motor is limited, the motor-in-the-middle configuration is often limited by the amount of torque that it can produce. That is, the motor in the motor-in-the-middle configuration may not be capable of generating enough torque for testing large trucks in accordance with government test specifications.

The present disclosure provides a dynamometer configuration (e.g., a chassis dynamometer configuration that includes two motors (i.e., one motor for each roll). Driving the two rolls with the two motors allows the rolls to rotate at different speeds (independently of each other) and allows the rolls to be loaded differently (i.e., different rotational loads). Furthermore, the dynamometer configuration of the present disclosure is compact in size, and yet still is able to generate a sufficient amount of torque at each of the rolls since each motor drives only one roll. Therefore, the size of the test chamber in which the dynamometer is disposed can be minimized and still accommodate an emission particulate tunnel. Accordingly, the dynamometer configuration of the present disclosure can reduce the cost associated with controlling the climate within the test chamber, while maintaining the functionality that enables more realistic test condition, accurate torque measurements and accurate emissions measurements.

In one form, the present disclosure provides a dynamometer system that may include a first dynamometer roll, a second dynamometer roll, a first motor, and a second motor. The first dynamometer roll is supported for rotation about a rotational axis. The second dynamometer roll may be supported for rotation about the rotational axis. The first motor may include an output shaft coupled to the first dynamometer roll for rotation therewith. The first motor may be drivingly connected to the first dynamometer roll at a first location. For example, the first location may be a connection between the output shaft of the first motor and an axle of the first dynamometer roll. The second motor may include an output shaft coupled to the second dynamometer roll for rotation therewith. The second motor may be drivingly connected to the second dynamometer roll at a second location. For example, the second location may be a connection between the output shaft of the second motor and an axle of the second dynamometer roll. The first motor may be disposed between the first location and the second location in a direction extending along the rotational axis. The second location may be disposed between the first motor and the second motor in the direction extending along the rotational axis.

In some configurations, an outer rim of the first dynamometer roll encircles the first motor.

In some configurations, an outer rim of the second dynamometer roll encircles the first motor.

In some configurations, the outer rim of the second dynamometer roll encircles the second motor.

In some configurations, the dynamometer system is a chassis dynamometer system.

### DRAWINGS

The drawings described herein are for illustrative purposes only of selected embodiments and not all possible implementations, and are not intended to limit the scope of the present disclosure.

FIG. 1 is a perspective view of a Class 8 truck on a chassis dynamometer having two motors disposed laterally outside of two dynamometer rolls;

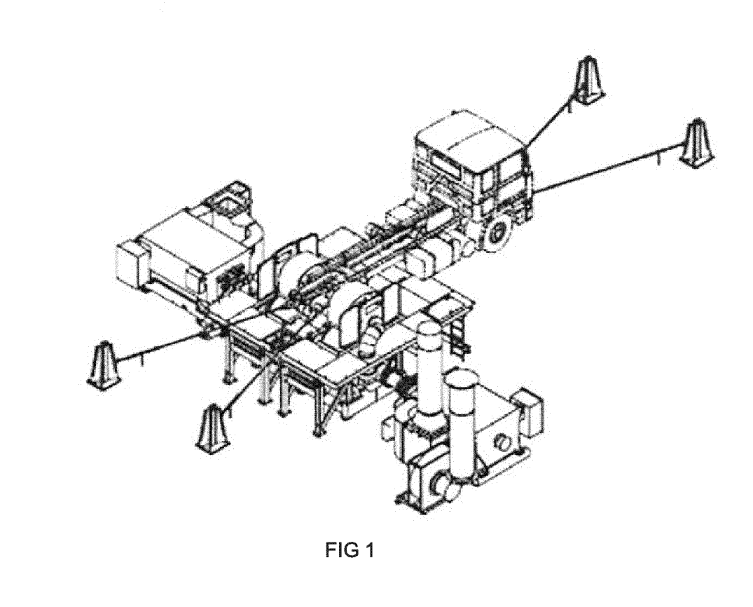

FIG. 2 is a rear view of the Class 8 truck on the dynamometer of FIG. 1;

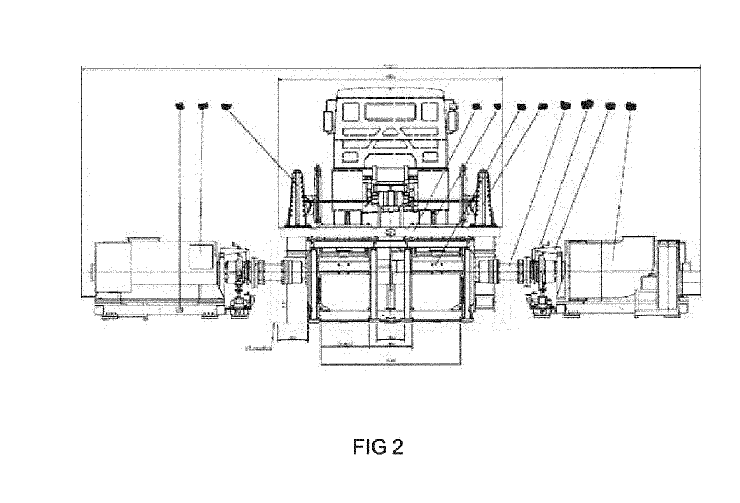

FIG. 3 is a schematic representation of another chassis dynamometer having two motors, each driving a corresponding dynamometer roll;

FIG. 4 is a perspective view of a motor-in-the-middle dynamometer configuration;

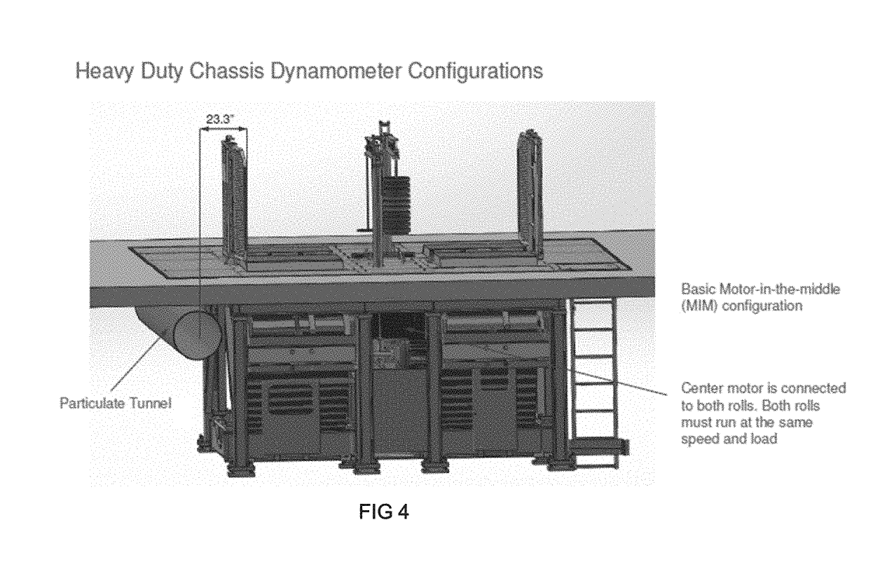

FIG. 5 is a perspective view of a dual-motor dynamometer configuration with motors disposed laterally outside of dynamometer rolls;

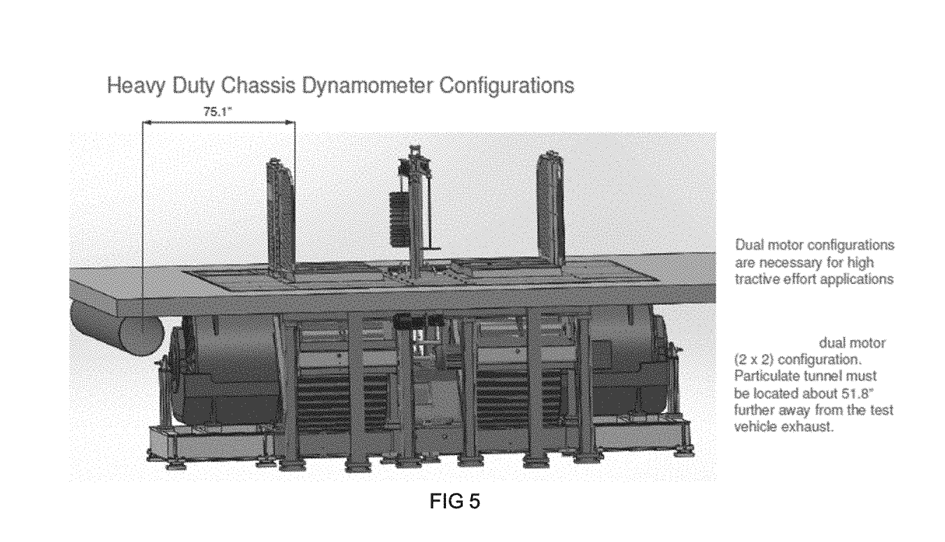

FIG. 6 is another perspective view of the dual-motor dynamometer configuration of FIG. 5;

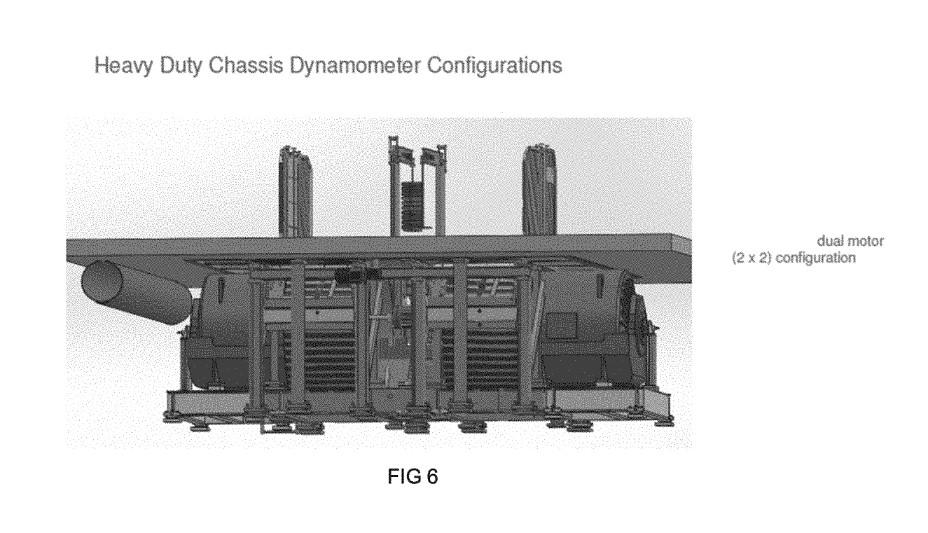

FIG. 7 is a perspective view of another dynamometer configuration similar to the dynamometer shown in FIG. 3; and

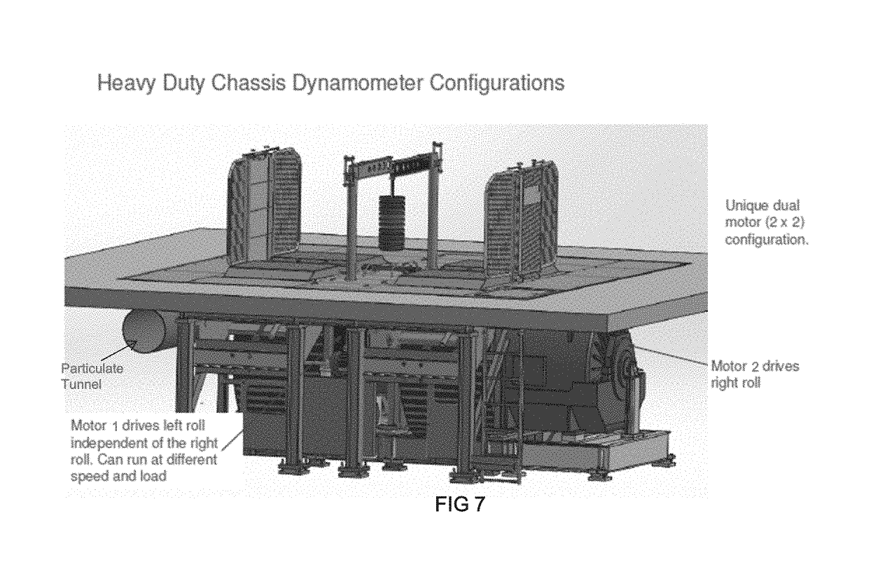

FIG. 8 is another perspective view of the dynamometer configuration of FIG. 7.

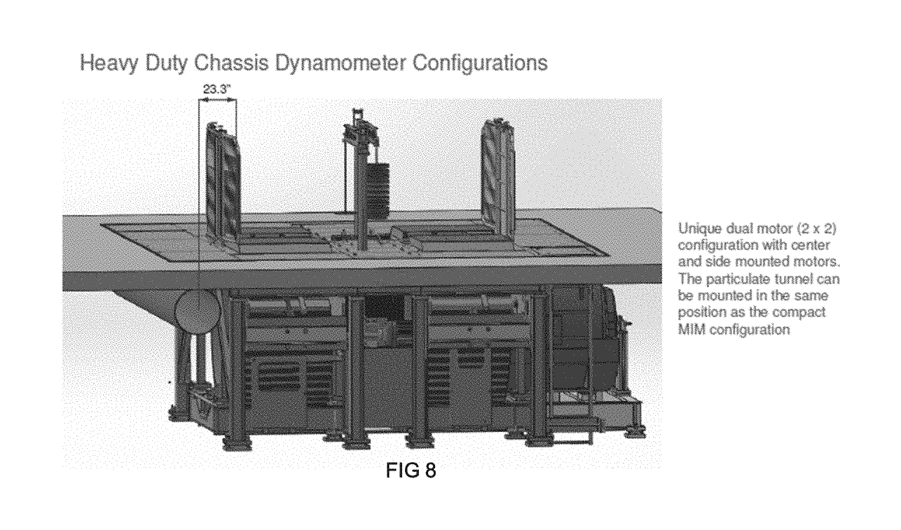

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

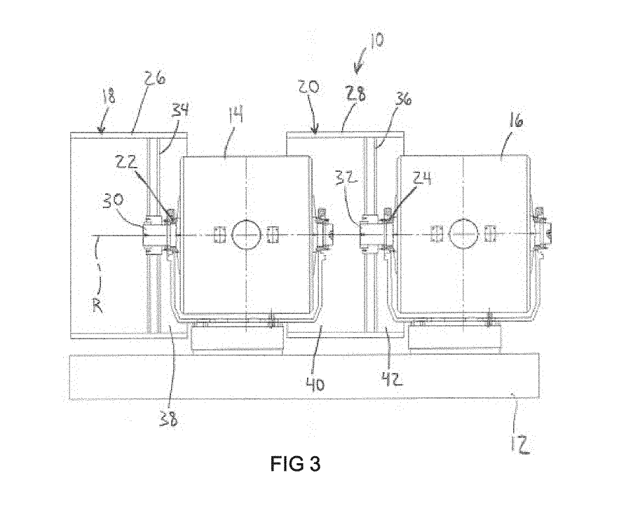

With reference to FIG. 3, a chassis dynamometer system 10 is provided that may include a foundation 12, a first motor 14, a second motor 16, a first dynamometer roll 18, and a second dynamometer roll 20. The foundation 12 can be a frame structure fixedly disposed on a floor of a test chamber (or test cell) in which the chassis dynamometer system 10 is located. Alternatively, the foundation 12 could be the floor of the test chamber.

The first and second motors 14, 16 may be mounted to the foundation 12 and/or any other stationary structure. In some configurations, the first and second motors 14, 16 may be identical. The first motor 14 includes a first output shaft 22, and the second motor 16 includes a second output shaft 24. The first output shaft 22 is coupled to the first dynamometer roll 18 such that the first motor 14 can rotationally drive and be driven by the first dynamometer roll 18. The second output shaft 24 is coupled to the second dynamometer roll 20 such that the second motor 16 can rotationally drive and be driven by the second dynamometer roll 20.

The first and second motors 14, 16 can be any suitable type of motor. For example, the first and second motors 14, 16 may be electric motor/generators that use alternating current (AC) or direct current (DC). In such a configuration, the first and second motors 14, 16 can generate electricity by being driven by the wheels of the vehicle (via the dynamometer rolls 18, 20). The electricity generated can then be measured to determine the force, torque, and power generated by the vehicle. Alternatively, the first and second motors 14, 16 can draw electricity to drive the dynamometer rolls 18, 20 and thus the wheels of the vehicle or to create a simulated load. The electrical current that the first and second motors 14, 16 draw can be controlled and measured to calculate power, friction losses, and/or pumping losses, for example. Of course, the use of other types of dynamometer motors is possible and is considered to be within the scope of the present disclosure.

The first and second dynamometer rolls 18, 20 may include first and second cylindrical outer rims 26, 28, respectively, that can engage and be driven by the wheels of the vehicle during testing. More specifically, the wheels of the vehicle may rest on the cylindrical outer rims 26, 28 such that the dynamometer rolls 18, 20 spin with the wheels of the vehicle during testing. The first and second dynamometer rolls 18, 20 may also include first and second axles 30, 32, respectively. Support members 34, 36 may connect the first and second axles 30, 32 to the first and second cylindrical outer rims 26, 28, respectively. The first and second axles 30, 32 may be coupled to the first and second output shafts 22, 24 of the motors 14, 16, respectively. In this manner, the first dynamometer roll 18 and the first output shaft 22 of the first motor 14 may rotate together, and the second dynamometer roll 20 and the second output shaft 24 of the second motor 16 may rotate together.

The first motor 14 may be disposed between the first and second dynamometer rolls 18, 20 and/or between the support members 34, 36 of the first and second dynamometer rolls 18, 20 in a direction extending along a rotational axis R about which the first and second dynamometer rolls 18, 20 rotate. In some configurations, one or both of the first and second cylindrical outer rims 26, 28 may extend around (i.e., encircle) the first motor 14. That is, the first motor 14 may be at least partially received inside of a first recess 38 defined by the first cylindrical outer rim 26 and/or at least partially received inside of a second recess 40 defined by the second cylindrical outer rim 28.

The second motor 16 may be positioned laterally outside of the support member 36 of the second dynamometer roll 20. In other words, the support member 36 of the second dynamometer roll 20 may be disposed between the first motor 14 and the second motor 16 in a direction extending along the rotational axis R. In some configurations, the second cylindrical outer rim 28 may extend around (i.e., encircle) the second motor 16. That is, the second motor 16 may be at least partially received inside of a third recess 42 defined by the second cylindrical outer rim 28. The support member 36 may separate the third recess 42 from the second recess 40.

The arrangement of the motors 14, 16 and the dynamometer rolls 18, 20 described above and shown in FIG. 3 reduces the overall width of the chassis dynamometer system 10. In some instances, the arrangement described above and shown in FIG. 3 reduces the overall width by approximately 30% compared to other chassis dynamometer configurations. Furthermore, the arrangement described above and shown in FIG. 3 provides space laterally outside of the first dynamometer roll 18 (i.e., to the left of the first dynamometer roll 18 in FIG. 3) for mounting an emission particulate tunnel (not shown in FIG. 3) for emissions testing. That is, the space laterally outside of the first dynamometer roll 18 allows the emission particulate tunnel to be positioned in close proximity to the tailpipe of the vehicle.

Driving the first and second dynamometer rolls 18, 20 with the first and second motors 14, 16, respectively, allows the dynamometer rolls 18, 20 to rotate at different speeds (independently of each other) and allows the dynamometer rolls 18, 20 to be loaded differently (i.e., different rotational loads) by the motors 14, 16. Furthermore, the dynamometer system 10 of the present disclosure is compact in size, and yet still is able to generate a sufficient amount of torque at each of the dynamometer rolls 18, 20. Therefore, the size of the test chamber in which the dynamometer system 10 is disposed can be minimized and still accommodate an emission particulate tunnel. Accordingly, the dynamometer system 10 can reduce the cost associated with controlling the climate within the test chamber, while maintaining the functionality that enables more realistic test condition, accurate torque measurements and accurate emissions measurements.

While the dynamometer system 10 is described above as being a chassis dynamometer system, it will be appreciated that the principles of the present disclosure could be applied to other types of dynamometer systems.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A dynamometer system comprising:
a first dynamometer roll supported for rotation about a rotational axis;
a second dynamometer roll supported for rotation about the rotational axis;
a first motor having an output shaft coupled to the first dynamometer roll for rotation therewith, the first motor drivingly connected to the first dynamometer roll at a first location; and
a second motor having an output shaft coupled to the second dynamometer roll for rotation therewith, the second motor drivingly connected to the second dynamometer roll at a second location,
wherein the first motor is disposed between the first location and the second location in a direction extending along the rotational axis, and wherein the second location is disposed between the first motor and the second motor in the direction extending along the rotational axis.

2. The dynamometer system of claim 1, wherein an outer rim of the first dynamometer roll encircles the first motor.

3. The dynamometer system of claim 1, wherein an outer rim of the second dynamometer roll encircles the first motor.

4. The dynamometer system of claim 1, wherein the outer rim of the second dynamometer roll encircles the second motor.

5. The dynamometer system of claim 1, wherein the dynamometer system is a chassis dynamometer system.
